(19) United States
(12) Patent Application Publication
(10) Pub. No.: US 2023/0186077 A1
(43) Pub. Date: Jun. 15, 2023

(54) ADAPTIVE TOKEN DEPTH ADJUSTMENT IN TRANSFORMER NEURAL NETWORKS

(71) Applicant: NVIDIA CORPORATION, Santa Clara, CA (US)

(72) Inventors: Hongxu YIN, San Jose, CA (US); Jan KAUTZ, Lexington, MA (US); Jose Manuel ALVAREZ LOPEZ, Mountain View, CA (US); Arun MALLYA, Mountain View, CA (US); Pavlo MOLCHANOV, Mountain View, CA (US); Arash VAHDAT, Mountain View, CA (US)

(21) Appl. No.: 17/841,577

(22) Filed: Jun. 15, 2022

Related U.S. Application Data
(60) Provisional application No. 63/287,938, filed on Dec. 9, 2021.

(51) Int. Cl. G06N 3/08; G06N 3/04

(52) U.S. Cl. CPC G06N 3/08; G06N 3/0481

(57) ABSTRACT

One embodiment of the present invention sets forth a technique for executing a transformer neural network. The technique includes computing a first set of halting scores for a first set of tokens that has been input into a first layer of the transformer neural network. The technique also includes determining that a first halting score included in the first set of halting scores exceeds a threshold value. The technique further includes in response to the first halting score exceeding the threshold value, causing a first token that is included in the first set of tokens and is associated with the first halting score not to be processed by one or more layers within the transformer neural network that are subsequent to the first layer.

### CROSS-REFERENCE TO RELATED APPLICATIONS

This application claims benefit of United States Provisional Patent Application titled “TECHNIQUES FOR ADJUSTING ADAPTIVE TOKEN DEPTH FOR NETWORKS WITH TRANSFORMER BLOCKS,” filed Dec. 9, 2021, and having Ser. No. 63/287,938. The subject matter of this related application is hereby incorporated herein by reference.

### BACKGROUND

### Field of the Various Embodiments

Embodiments of the present disclosure relate generally to machine learning and computer science and, more specifically, to adaptive token depth adjustment in transformer neural networks.

### DESCRIPTION OF THE RELATED ART

A transformer is a type of deep neural network that operates on a set of tokens that represent words, regions of images, or other discrete units of data. A typical transformer includes multiple layers of transformer blocks that operate on the tokens using an attention unit that mimics cognitive attention. During operation, the attention unit performs a series of matrix multiplication operations to compute a set of attention scores for each token inputted into the transformer. Each attention score represents the level of contextual relevance between a unit of data represented by a given token inputted into the transformer and all other units of data represented by the other tokens inputted into the transformer. The attention scores are used to “transform” the tokens, where a relatively higher attention score between a given token and some other token increases the contribution of the other token to the transformed value of the given token, and a relatively lower attention score between a given token and some other token decreases the contribution of the other token to the transformed value of the given token.

For example, a vision transformer could be used to recognize an object in an image. The image could be divided into a sequence of non-overlapping fixed-size patches. The patches could be converted into a set of tokens, where each token corresponds to a different patch in the image. The tokens could then be processed by a series of transformer blocks that share a common architecture but have different sets of weights. Each transformer block could include an attention unit that computes a different set of attention scores for each token. Each attention score could represent the strength of a semantic relationship between the patch represented by the token and every other patch in the image. The transformer block could combine a representation of each token inputted into the transformer block with the attention scores between the token and each other token inputted into the transformer block to “transform” the token into a corresponding output token. During the transformation of a given input token into a corresponding output token, the contribution of another input token to the output token would be scaled by the attention score between the given input token and the other input token. The tokens outputted by the last transformer block could then be processed by one or more neural network layers to generate a prediction of the type of object depicted in the image.

One drawback of using transformers to perform machine learning tasks is that transformers incurs more latency and resource overhead than other neural network architectures. In particular, the series of matrix multiplication operations used to compute attention scores at each transformer block is usually more computationally intensive than the operations involved in executing convolutional neural networks, recurrent neural networks, or other non-transformer neural network architectures. For example, the computational cost of the attention unit in a transformer neural network architecture could scale quadratically with the number of tokens, while the computational cost of a recurrent neural network could scale only linearly with the number of inputs. The high computational costs associated with transformers limits the usefulness of transformers in devices or environments with limited computational capabilities, power, memory, and/or network bandwidth.

As the foregoing illustrates, what is needed in the art are more effective techniques for implementing transformer neural networks.

### SUMMARY

One embodiment of the present invention sets forth a technique for executing a transformer neural network. The technique includes computing a first set of halting scores for a first set of tokens that has been input into a first layer of the transformer neural network. The technique also includes determining that a first halting score included in the first set of halting scores exceeds a threshold value. The technique further includes, in response to the first halting score exceeding the threshold value, causing a first token that is included in the first set of tokens and is associated with the first halting score not to be processed by one or more layers within the transformer neural network that are subsequent to the first layer.

One technical advantage of the disclosed techniques relative to the prior art is that, with the disclosed techniques, the number of tokens processed by a transformer neural network is reduced as inferencing operations proceed. Accordingly, with the disclosed techniques, the transformer neural network can execute more quickly and efficiently than a conventional transformer neural network that processes all input tokens using all layers. The improvements in execution speed and efficiency additionally enable transformer neural networks to be deployed on mobile phones, autonomous vehicles, or other edge devices with limited computational capabilities, memory, power, and/or network bandwidth. Another technical advantage of the disclosed techniques is that the transformer neural network can be trained in a way that balances the accuracy of the transformer neural network in performing a task with the efficiency with which the transformer neural network performs the task. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of the various embodiments.

FIG. 2 is a more detailed illustration of the training engine and execution engine of FIG. 1, according to various embodiments.

FIG. 3 illustrates how tokens are processed by the transformer of FIG. 2, according to various embodiments.

FIG. 4 is a flow diagram of method steps for training a transformer neural network, according to various embodiments.

FIG. 5 is a flow diagram of method steps for executing a trained transformer neural network, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### General Overview

A transformer is a type of deep neural network that operates on a set of tokens representing words, regions of images, or other discrete units of data. The transformer includes multiple layers of transformer blocks that operate on the tokens using attention units that mimic cognitive attention. The attention unit performs a series of matrix multiplication operations to compute a set of attention scores for each token. Each attention score represents the relative importance of another token to the token. The attention scores are used to “transform” the tokens, so that a relatively higher attention score between a given token and another token increase the contribution of the other token to the transformed value of the given token, and a relatively lower attention score between the given token with and another token decreases the contribution of the other token to the transformed value of the given token.

Transformers can be used in various real-world applications. First, transformers can be used to transform input text sequences into output text sequences that are semantically relevant to the input text sequences. For example, a transformer could be used to translate an input sentence in a first language into an output sentence in a second language, output an answer in response to an input question, output a summary of an input document, and/or perform another task that generates an output sequence of text, given an input sequence of text. Second, transformers can be used to convert between images and non-image data. For example, an image could be divided into a sequence of fixed-size non-overlapping patches, and the patches could be converted into tokens. A transformer could then be used to process the tokens and generate a caption for the image, detect an object in the image, classify the image and/or object, or generate other output that describes the content of the image. Consequently, transformers can be used in autonomous vehicles, robots, augmented reality systems, and/or other environments or systems that utilize computer vision techniques.

One drawback of using a transformer to perform a machine learning task is that the transformer incurs more latency and resource overhead than other neural network architectures. In this regard, the series of matrix multiplication operations used to compute attention scores at each transformer block is more computationally intensive than the operations involved in executing convolutional neural networks, recurrent neural networks, or other non-transformer neural network architectures. For example, the computational cost of the attention unit in a transformer neural network architecture could scale quadratically with the number of tokens, while the computational cost of a recurrent neural network could scale linearly with the number of inputs. This high computational cost limits the ability to use transformers in devices or environments with limited memory, power, network bandwidth, and/or computational capabilities.

To reduce the resource overhead associated with executing a transformer, a halting score is computed for each token inputted into the transformer at each layer of the transformer. Each halting score represents a probability that processing of a corresponding token is to be discontinued after the layer. For example, a halting module could compute each halting score as a value ranging between 0 and 1. The halting score could be calculated by shifting and/or scaling input that includes one or more elements (e.g., one or more embedding dimensions) of the corresponding token and applying a nonlinear function to the result.

As a set of tokens progresses through the layers of the transformer, halting scores computed at previous layers are aggregated into cumulative halting scores for the tokens. For example, a cumulative halting score for a token at a given layer of the transformer could be generated by summing all halting scores computed for the token from the first layer of the transformer up to the given layer. When the cumulative halting score for a given token exceeds a threshold, processing of the token by subsequent layers of the transformer is discontinued, or halted. For example, processing of a token by the transformer could be halted by zeroing out the value of the token and blocking the computation of attention scores involving the token. Because tokens that are determined to be relatively unimportant to the task performed by the transformer are halted in earlier layers, the transformer is able to execute more efficiently than a conventional approach that processes all sets of tokens using all layers of a transformer.

### System Overview

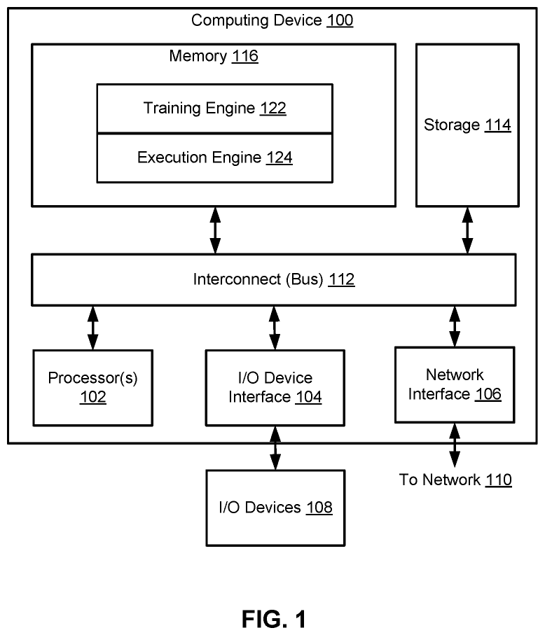

FIG. 1 illustrates a computing device 100 configured to implement one or more aspects of the various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In one embodiment, I/O devices 108 include devices capable of receiving input, such as a keyboard, a mouse, a touchpad, and/or a microphone, as well as devices capable of providing output, such as a display device and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and external entities or devices, such as a web server or another networked computing device. For example, network 110 could include a wide area network (WAN), a local area network (LAN), a wireless (WiFi) network, and/or the Internet, among others. Network 110 could connect multiple instances of computing device 100 (e.g., within a data center, cluster, cloud computing environment, etc.) to allow training engine 122 and execution engine 124 to operate in a parallel, distributed, and/or scalable fashion.

In one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

In one embodiment, memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

Training engine 122 trains a transformer neural network to perform a task, and execution engine 124 executes one or more portions of the transformer neural network to generate predictions and/or other output related to the task. For example, training engine 122 could train the transformer neural network to perform image classification, object detection, semantic segmentation, and/or another type of computer vision task. Execution engine 124 could use the trained transformer neural network to predict classes, identify objects, and/or generate other output related to an image or individual pixels in the image.

In one or more embodiments, training engine 122 and execution engine 124 are configured to perform adaptive token depth adjustment in the transformer neural network, in which processing of certain tokens is selectively discontinued before the tokens reach the final layer of the transformer neural network. As described in further detail below, each layer of the transformer neural network includes a transformer block and a halting module. During training of the transformer neural network, training engine 122 updates the parameters of the halting module within each layer so that the halting module learns to compute halting scores that reflect the relative importance of each token to the task performed by the transformer neural network. For example, training engine 122 could train each halting module so that the halting score outputted by the halting module is inversely proportional to the relative importance of the corresponding token to the task.

After the transformer neural network is trained, execution engine 124 executes the transformer neural network based on the halting scores computed by the halting module in each layer. For example, execution engine 124 could discontinue processing of a token after a certain layer of the transformer neural network once a sum of halting scores for the token from up to the layer exceeds a threshold. Because tokens that are identified as relatively unimportant to the task performed by the transformer neural network are not processed by all layers of the transformer neural network, the transformer neural network can execute more quickly and efficiently than a conventional transformer neural network that processes all input tokens using all layers.

### Adaptive Token Depth Adjustment in Transformer Neural Networks

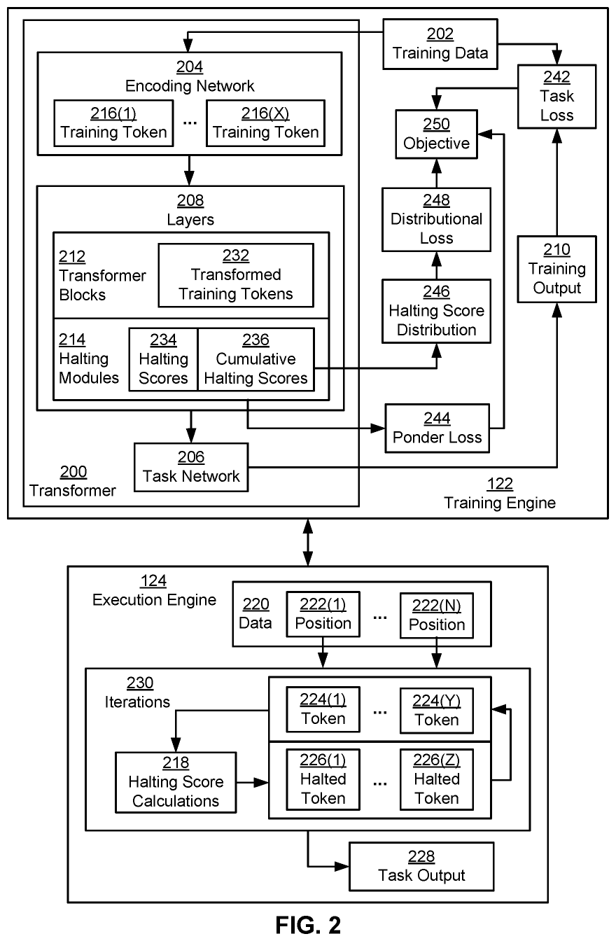

FIG. 2 is a more detailed illustration of training engine 122 and execution engine 124 of FIG. 1, according to various embodiments. As mentioned above, training engine 122 and execution engine 124 operate to train and execute a neural network with a transformer 200 architecture.

As shown in FIG. 2, transformer 200 includes an encoding network 204, a number of layers 208, and a task network 206. Encoding network 204 converts subsets of data 220 associated with different positions 222(1)-222(N) (each of which is referred to individually as position 222) into tokens 224(1)-224(Y) (each of which is referred to individually as token 224). For example, encoding network 204 could include a series of fully connected layers that convert fixed-size patches from various positions 222 within an image into a corresponding set of tokens 224. Each token could include an embedding of the corresponding patch in a lower-dimensional latent space. After a given token is produced, a “positional encoding” representing the position (e.g., x-coordinate, y-coordinate, pixel locations, etc.) of the corresponding patch could be added to the token to generate a position-encoded token representing the patch.

Tokens 224 generated by encoding network 204 are processed by a series of layers 208 with the same architecture. Continuing with the above example, the series of layers 208 could process position-encoded tokens 224 representing different subsets of data 220 over a number of iterations 230, where the number of iterations 230 is equal to the number of layers 208. The series of layers 208 could also process one or more tokens 224 that are not generated by encoding network 204, such as a class token that can be used to predict one or more classes associated with data 220.

In one or more embodiments, layers 208 include transformer blocks 212 that use attention units to iteratively update tokens 224. For example, a given transformer block in layers 208 could receive, as input, a set of tokens outputted by a transformer block from a previous layer of transformer 200. When the transformer block resides in the first layer, input into the transformer block could include position-encoded tokens 224 generated by encoding network 204 from data 220. The transformer block could include a multi-head attention unit, a multilayer perceptron, one or more normalization layers, and/or one or more residual connections from the input of a given component (e.g., multi-head attention and normalization, fully connected and normalization, etc.) to the output of the same component. The transformer block could also, or instead, include a vision transformer (ViT) architecture, a data-efficient image transformer (DeiT) architecture, a convolutional-like ViT (ConViT) architecture, Class-Attention in Image Transformers (CaiT) architecture, and/or another type of transformer architecture. The output of the transformer block includes a set of updated tokens 224 that have been processed by the various components within the transformer block.

Transformer 200 additionally includes a task network 206 that generates task output 228 related to a task based on tokens 224 outputted by the last transformer block in layers 208. For example, task network 206 could include one or more fully connected layers that generate a predicted class for an image or an object in an image, given one or more tokens 224 (e.g., one or more class tokens) outputted by one or more transformer blocks 212 in layers 208.

In some embodiments, the operation of transformer 200 is represented using the following:

y=∘ [symbol] ∘ [symbol] ^{L}∘ [symbol] ^{L-1}∘ . . . ∘ [symbol] ¹∘ε(x) (1)

In the above equation, x ∈ [symbol] ^{C×H×W} (where C, H, and W represent channel, height, and width respectively) is an input image (or another type of input data), and y is a prediction generated by transformer 200 from the input image. Encoding network 204 is denoted by ε(·) and converts patches from x into position-encoded tokens 224 t ∈ [symbol] ^{K×E}, where K represents the total number of tokens 224 and E represents a consistent embedding dimension for each token across all layers 208. Tokens 224 are iteratively transformed by L layers 208 of transformer blocks 212 [symbol] (·) via self-attention. One or more tokens 224 outputted by the one or more transformer blocks 212 are then post-processed by task network 206 [symbol] (·) into task output 228.

The operation of a transformer block in layer l can be represented using the following:

t_{1:K}^{l}= [symbol] ^{l}(t_{1:K}^{l-1}) (2)

In the above equation, t_{1:K}^{l} denotes K tokens 224 outputted by the transformer block in layer l, and t_{1:K}^{l-1} represents K tokens 224 that are outputted by the transformer block in the previous layer (i.e., layer l−1) and inputted into the transformer block in layer l. Additionally, t_{1:K}⁰=ε(x) (i.e., the first set of tokens 224 is produced by encoding network 204 from patches in the input image).

As shown in FIG. 2, layers 208 also include halting modules 214 that perform halting score calculations 218 related to tokens 224 outputted by the corresponding transformer blocks 212. In one or more embodiments, halting score calculations 218 include the generation of halting scores 234 for individual tokens 224 at each layer. Halting score calculations 218 also include the aggregation of halting scores 234 computed over the series of layers 208 into cumulative halting scores 236 for individual tokens 224 at each layer. When a given cumulative halting score exceeds a threshold, the corresponding token is “halted,” or no longer processed by subsequent layers 208 of transformer 200.

The operation of a halting module at layer l can be represented using the following:

hₖ^{l}=H(tₖ^{l}) (3)

In the above equation, the halting module is represented by H(·) and generates a halting score hₖ^{l} for the kth token outputted by the transformer block in the same layer. The halting score is enforced to be in the range of [0, 1].

The computation and use of a cumulative halting score for a token can be represented using the following:

$${N}_{k} = {argmin}_{n \leq L} {\sum }_{l = 1}^{n} {h}_{k}^{l} \geq 1 - ϵ \qquad ( 4 )$$

In the above equation, the cumulative halting score for the kth token is computed as the summation of halting scores 234 from the first n layers. Nₖ represents the earliest layer for which the cumulative halting score exceeds a threshold of 1−∈, where E is a small positive constant (e.g., 0.02) that allows a token to be halted after one layer. Once the cumulative halting score exceeds the threshold, processing of the token is halted. Further, stopping at the final layer is enforced by defining h_{1:K}^{L=}1 for all tokens 224.

In one or more embodiments, each of halting scores 234 is calculated using the following:

H(tₖ^{l})=σ(γ·t_{k,e}^{l}+β) (5)

In the above equation, t_{k,e}^{l} represents the eth dimension of token tₖ^{l} and

$$σ ( u ) = \frac{1}{1 + {exp}^{- u}}$$

is the logistic sigmoid function. Consequently, the halting score is computed from a single dimension of each token instead of requiring additional learned parameters or sub-networks in transformer 200. Further, β and γ are shifting and scaling hyperparameters, respectively, that adjust the eth dimension of token tₖ^{l} before a non-linearity corresponding to the logistic sigmoid function is applied. For example, β could be set to a negative value (e.g., −10) to mitigate the generation of overly large halting scores 234 and allow transformer to be trained across all layers 208. γ could be set to a positive value greater than 1 (e.g., 5) to increase the range of values from which the halting score is calculated. The same values of β and γ can be used across all layers 208 for all tokens 224.

Training engine 122 trains transformer 200 using training data 202 and an objective 250 that includes a task loss 242, a ponder loss 244, and/or a distributional loss 248. More specifically, training engine 122 inputs training data 202 (e.g., images) into encoding network 204 and receives a number of training tokens 216(1)-216(X) (each of which is referred to individually as training token 216) as output of encoding network 204. Training engine 122 inputs training tokens 216 into layers 208 of transformer blocks 212 to iteratively generate multiple sets of transformed training tokens 232. Training engine 122 also uses halting modules 214 in the same layers 208 to compute halting scores 234 and cumulative halting scores 236 for the corresponding transformed training tokens 232. When a cumulative halting score for a token included in transformed training tokens 232 exceeds a threshold, the token is halted for all subsequent layers 208 by zeroing out the value of the token and blocking the computation of attention scores involving the token by subsequent transformer blocks 212.

After transformed training tokens 232 have been processed by all layers 208 and/or halted, training engine 122 uses task network 206 to convert one or more transformed training tokens 232 into training output 210 (e.g., predictions of classes) associated with training data 202. Finally, training engine 122 uses training data 202 and/or various outputs of transformer 200 to compute task loss 242, ponder loss 244, distributional loss 248, and/or objective 250. Training engine 122 additionally uses a training technique (e.g., gradient descent and backpropagation) to update parameters of encoding network 204, layers 208, and/or task network 206 based on objective 250.

During training of transformer 200, training engine 122 computes a remainder rₖ for each token using the following:

$${r}_{k} = 1 - {\sum }_{l = 1}^{{N}_{k} - 1} {h}_{k}^{l} \qquad ( 6 )$$

The remainder represents an “adjusted” halting score for the layer Nₖ at which the kth token is halted. This “adjusted” halting score is computed as the difference between the cumulative halting score for the token up to the layer Nₖ and the upper bound of 1 for halting scores 234.

Training engine 122 then uses the remainder to compute a halting probability pₖ^{l} for the kth token at layer l:

$${p}_{k}^{l} = \{ \begin{matrix}0 if l > {N}_{k} \\ {r}_{k} if l = {N}_{k} \\ {h}_{k}^{l} if l < {N}_{k}\end{matrix} \qquad ( 7 )$$

The halting probability is set to the halting score for each layer prior to Nₖ and set to the remainder for the layer Nₖ. The halting probability is then set to 0 for all layers 208 subsequent to Nₖ in transformer 200. Because Σₗ^{L}=₁pₖ^{l} and 0≤pₖ^{l}≤1, halting probabilities pₖ^{l} adhere to a valid probability distribution.

In one or more embodiments, ponder loss 244 is formulated via the remainder and the layer at which each token is halted:

$${ℒ}_{ponder} := \frac{1}{K} {\sum }_{k = 1}^{k} {ρ}_{k} = \frac{1}{K} {\sum }_{k = 1}^{k} ( {N}_{k} + {r}_{k} ) \qquad ( 8 )$$

In the above equation, a per-token ponder loss ρₖ is averaged across K transformed training tokens 232 to produce an overall ponder loss 244 denoted by [symbol] _{ponder}. Because ρₖ is computed as the sum of Nₖ and rₖ that both depend on halting scores 234 hₖ^{l} and/or cumulative halting scores 236, ponder loss 244 controls the points at which various tokens 224 are halted.

As mentioned above, tokens 224 can include a class token denoted by t_{c} that is separate from tokens 224 representing specific subsets of data 220. Like other tokens 224, the class token is updated by transformer blocks 212 in layers 208 of transformer 200. During training of transformer 200, values of the class token can be used to compute task loss 242:

$${ℒ}_{t a s k} = 𝒞 ( {t}_{o} ) , where {t}_{o} = {\sum }_{l = 1}^{L} {p}_{c}^{l} {t}_{c}^{l} \qquad ( 9 )$$

In the above equation, task loss 242 is represented by [symbol] ₜₐₛₖ and is computed based on training output 210 that is generated by task network 206 from an output token t₀. The output token is computed using a mean field formulation that includes a weighted sum of values of the class token across all layers 208. Weights applied to the class token values in the weighted sum correspond to halting probabilities for the same layers 208.

In some embodiments, training engine 122 combines task loss 242 and ponder loss 244 into an overall objective 250 that is used to train transformer 200. For example, objective 250 could include the following representation:

[symbol]

ₒᵥₑᵣₐₗₗ= [symbol] ₜₐₛₖ+αₚ [symbol] _{ponder} (10)

In the above equation, [symbol] ₒᵥₑᵣₐₗₗ represents objective 250 (e.g., an “overall” loss), and αₚ is a scaling factor that scales ponder loss 244 relative to task loss 242. The above representation of objective 250 allows for a tradeoff between accuracy and efficiency when “pondering” tokens 224 at various layers 208 of transformer 200. A larger value of αₚ causes transformer 200 to halt tokens 224 earlier, while a smaller value of αₚ potentially increases the predictive accuracy of transformer.

The following example sequence of steps can be used to perform computations related to ponder loss 244 and task loss 242:

```
Input: tokenized input tensor input ∈ [symbol]   ^{K×E}, with class token index c in K
and 0 ≤ ϵ ≤ 1
Output: aggregated output tensor out, ponder loss ρ
Initialize values:
  t = input
  cumul = 0
  R = 1
  out = 0
  ρ = 0
  m = 1
Iterate over layers:
  for l = 1, . . . , L do
    t = [symbol]   ^{l}(t ⊙ m)
    if l < L then h = σ(γ · t_{;,e} + β) else h = 1
    cumul += h
    ρ += m
    for k = 1, . . . , K do
      if cumulₖ < 1 − ϵ then Rₖ −= hₖ else ρₖ += Rₖ
    endfor
    if cumul_{c} < 1 − ϵ then out += t_{c,;} × h_{c} else out += t_{c,;} × R_{c}
    m ← cumul < 1 − ϵ
  endfor
Generate output:
  $return out , ρ = \frac{sum ( ρ )}{K}$
```

In the above sequence, t is a tensor of tokens that includes a class token indexed by c, cumul is a vector of cumulative halting scores 236 for the tokens, R is a vector of remainder values for the tokens, out is an output tensor, ρ is a vector of per-token ponder losses, and m is a vector of token masks. These values are initialized and subsequently updated by iterating over layers 208 of transformer 200.

During each iteration, a transformer block in a corresponding layer is applied to an element-wise product of token values and token masks outputted by the previous layer to produce an updated set of token values t. For every layer except the final layer, a vector of halting scores 234 h is computed from a dimension e in t. For the final layer, all elements of h are set to 1. Cumulative halting scores 236 in cumul are also updated by adding halting scores 234 to the existing values of cumulative halting scores 236. Values of the token masks are added to the per-token ponder losses to increment the Nₖ component in each per-token ponder loss. The remainders and/or per-token ponder losses for the tokens are then updated based on cumulative halting scores 236 in cumul and halting scores 234 in h. If the cumulative halting score for the class token falls below the threshold of 1−∈, a value of the class token weighted by the halting score for the class token is added to the output tensor out. If the cumulative halting score for the class token does not fall below the threshold of 1−∈, a value of the class token weighted by the remainder for the class token is added to the output tensor. At the end of each iteration, the vector of token masks m is updated so that a given token mask is set to 0 when the cumulative halting score for the corresponding token is greater than or equal to the threshold of 1−∈ and to 1 otherwise.

After iteration over all layers 208 is complete, ponder loss 244 is computed as the average per-token ponder loss. Ponder loss 244 is then returned with the output tensor that includes a weighted sum of values of the class token across all layers 208. The output tensor can be used to compute task loss 242, and task loss 242 and ponder loss 244 can be combined into an overall objective 250 that is used to train transformer 200, as discussed above.

In some embodiments, the accuracy-efficiency tradeoff associated with ponder loss 244 and task loss 242 in objective 250 is controlled using distributional loss 248. More specifically, training engine 122 uses a distributional prior to regularize a halting score distribution 246 of halting scores 234 for transformed training tokens 232. This regularization of halting scores 234 encourages transformed training tokens 232 to be halted at an expected target layer while allowing for variations within the distributional prior across images or other samples of training data 202.

In one or more embodiments, halting score distribution 246 includes the following representation:

$$ℋ := [ \frac{{\sum }_{k = 1}^{K} {h}_{k}^{1}}{K} , \frac{{\sum }_{k = 1}^{K} {h}_{k}^{2}}{K} , … , \frac{{\sum }_{k = 1}^{K} {h}_{k}^{L}}{K} ] \qquad ( 11 )$$

In the above equation, [symbol] represents halting score distribution 246 and is computed as the average of halting scores 234 across all layers 208 of transformer 200 (i.e., [symbol] ∈ [symbol] ^{L}) for a given batch of training data 202.

Training engine 122 uses the following formulation of distributional loss 248 to regularize the above halting score distribution 246 toward a predefined distributional prior:

[symbol]

_{distr.}=KL( [symbol] ∥ [symbol] ^{target}) (12)

In the above equation, [symbol] _{distr.} represents distributional loss 248 and is computed as the KL divergence of halting score distribution 246 from a target halting score distribution represented by [symbol] ^{target}. The target halting score distribution can indicate an “expected” target layer at which cumulative halting scores 236 exceed the threshold for halting the corresponding transformed training tokens 232. For example, the target halting score distribution could include a Gaussian distribution that is centered at a target layer denoted by N^{target}.

A revised objective 250 that includes distributional loss 248 includes the following representation:

[symbol]

ₒᵥₑᵣₐₗₗ= [symbol] ₜₐₛₖ+α_{d} [symbol] _{distr.}+αₚ [symbol] _{ponder} (13)

In the above equation, α_{d} is a scalar coefficient that balances distributional loss 248 against task loss 242 and ponder loss 244. Values of α_{d} and αₚ can be selected to adjust the contributions of task loss 242, ponder loss 244, and distributional loss 248 to the training of transformer 200.

After training engine 122 has completed training of transformer 200, execution engine 124 executes the trained transformer 200 to generate task output 228 related to additional data 220 that is not included in training data 202. For example, execution engine 124 could input fixed-size patches associated with various positions 222 in an image into encoding network 204 and receive an initial set of tokens 224 as output of encoding network 204. Execution engine 124 could use a series of layers 208 to process the initial set of tokens 224 and a class token. More specifically, execution engine 124 could perform a number of iterations 230 that use transformer blocks 212 in layers 208 to update tokens 224. Each iteration could also use a halting module to perform halting score calculations 218 that generate halting scores 234 and cumulative halting scores 236 for the updated tokens 224 outputted by the transformer block in the same layer. Execution engine 124 could additionally identify one or more halted tokens 226(1)-226(Z) (each of which is referred to individually as halted token 226) based on comparisons of cumulative halting scores 236 with one or more thresholds. Execution engine 124 could prevent halted tokens 226 from being processed by subsequent layers 208 or iterations 230 by removing halted tokens 226 from input into the subsequent layers 208. After all tokens 224 have been halted and/or processed by all layers 208, execution engine 124 could use task network 206 to convert one or more class tokens 224 produced by iterations 230 into task output 228 that includes predictions of one or more classes related to the image.

While the operation of training engine 122 and execution engine 124 has been described above with respect to image-based data 220, it will be appreciated that training engine 122 and execution engine 124 can be used to train and execute transformers that operate on other types of data 220. For example, training engine 122 and execution engine 124 could be used to train and execute transformers that efficiently process text-based data, times series data, and/or other types of sequential data.

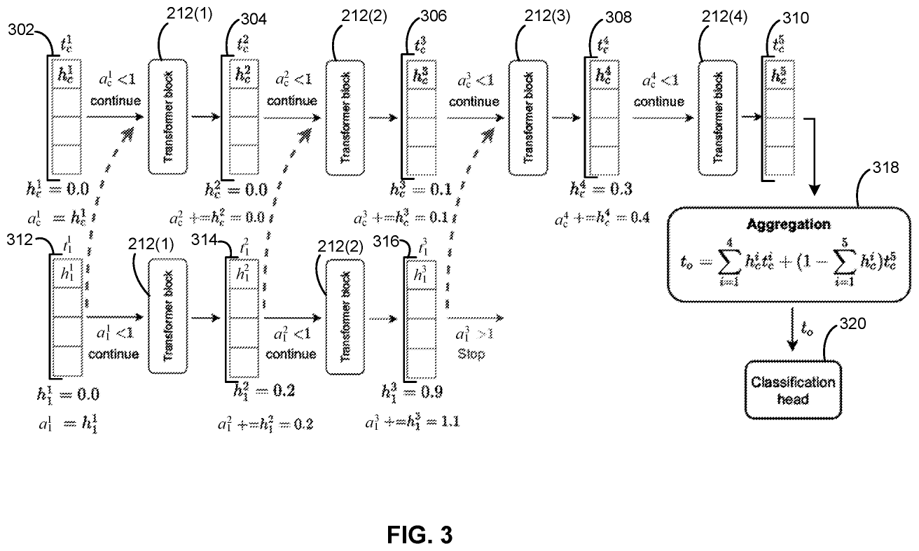

FIG. 3 illustrates how tokens are processed by transformer 200 of FIG. 2, according to various embodiments. As shown in FIG. 3, a first token corresponds to a class token with five different values 302-310 denoted by t_{c}¹, t_{c}², t_{c}³, t_{c}⁴, and t_{c}⁵, respectively. Value 302 can be learned during training of transformer 200 and/or computed by encoding network 204 from one or more portions of an input image (or another type of input data). Value 304 is generated by a first transformer block 212(1) from value 302 and additional values of other tokens inputted into the first transformer block 212(1). Value 306 is generated by a second transformer block 212(2) from value 304 and additional values of other tokens inputted into the second transformer block 212(2). Value 308 is generated by a third transformer block 212(3) from value 306 and additional values of other tokens inputted into the third transformer block 212(2). Value 310 is generated by a fourth transformer block 212(4) from value 308 and additional values of other tokens inputted into the fourth transformer block 212(4). Values 302-310 of the class token are combined via an aggregation 318 (e.g., a mean field formulation) into an output token t₀. The output token is inputted into a classification head 320 to produce a prediction of one or more classes associated with the input image.

A second token includes three different values 312-316 denoted by t₁¹, t₁², and t₁³. Value 312 can be computed by encoding network 204 from a patch in the input image (or another portion of input data). Value 314 is generated by the first transformer block 212(1) from value 312 and additional values of other tokens inputted into the first transformer block 212(1). Value 316 is generated by the second transformer block 212(2) from value 314 and additional values of other tokens inputted into the second transformer block 212(2). Unlike the class token, the second token is not processed by the third transformer block 212(3) or the fourth transformer block 212(4). Instead, processing of the second token is halted after the second transformer block 212(2).

As mentioned above, transformer 200 uses halting scores 234 and cumulative halting scores 236 to selectively process and halt tokens at various layers 208. In the example of FIG. 3, halting scores 234 for values 302-316 of the two tokens are computed using the first dimension of each token value.

More specifically, value 302 is associated with a halting score that is denoted by h_{c}¹ and has a value of 0.0. Value 304 is associated with a halting score that is denoted by h_{c}² and has a value of 0.0. Value 306 is associated with a halting score that is denoted by h_{c}³ and has a value of 0.1. Value 308 is associated with a halting score that is denoted by h_{c}⁴ and has a value of 0.3. Value 310 is associated with a remainder that is denoted by 1−Σᵢ₌₁⁵h_{c}ⁱ and has a value of 1−(0.1+0.3), or 0.6.

Value 312 is associated with a halting score that is denoted by h₁¹ and has a value of 0.0. Value 314 is associated with a halting score that is denoted by h₁² and has as value of 0.2. Value 316 is associated with a halting score that is denoted by h₁³ and has a value of 0.9.

Individual values 302-316 of the two tokens are also associated with cumulative halting scores 236. Each cumulative halting score is computed for each value of a corresponding token as a sum of previously computed halting scores 234 for the token. The cumulative halting score for value 302 is denoted by a_{c}¹ and set to the value of 0.0 for h_{c}¹. The cumulative halting score for value 304 is denoted by a_{c}² and includes a value of 0.0, which is obtained by adding the value of 0.0 for h_{c}² to the cumulative halting score for value 302. The cumulative halting score for value 306 is denoted by a_{c}³ and includes a value of 0.1, which is obtained by adding the value of 0.1 for h_{c}³ to the cumulative halting score for value 304. The cumulative halting score for value 308 is denoted by 4 and includes a value of 0.4, which is obtained by adding the value of 0.3 for h_{c}³ to the cumulative halting score for value 306. The cumulative halting score for value 310 is set to 1 to enforce halting of the token after the last transformer block 212(4). Because the cumulative halting score for the class token does not exceed a threshold of 1 until the final transformer block 212(4), the class token is not halted early.

The cumulative halting score for value 312 is denoted by a₁¹ and set to the value of 0.0 for h₁¹. The cumulative halting score for value 314 is denoted by a₁² and includes a value of 0.2, which is obtained by adding the value of 0.2 for h₁² to the cumulative halting score for value 312. The cumulative halting score for value 316 is denoted by a₁³ and includes a value of 1.1, which is obtained by adding the value of 0.9 for h₁³ to the cumulative halting score for value 314. Because the cumulative halting score for value 316 exceeds the threshold of 1, the second token is halted before the second token can be processed by the third transformer block 212(3). Before the second token is halted, values 312-316 of the second token are used by transformer blocks 212(1)-212(3) to compute values 304-308 of the class token. After the second token is halted, value 310 of the class token is computed by transformer block 212(4) without a corresponding value of the second token.

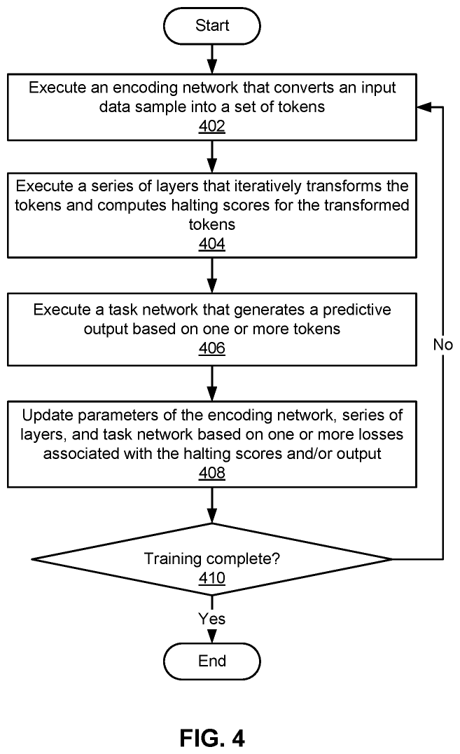

FIG. 4 is a flow diagram of method steps for training a transformer neural network, according to various embodiments. Although the method steps are described in conjunction with the systems of FIGS. 1-2, persons skilled in the art will understand that any system configured to perform the method steps in any order falls within the scope of the present disclosure.

As shown, training engine 122 executes 402 an encoding network that converts an input data sample into a set of tokens. For example, the encoding network could convert fixed-size patches in an image into position-encoded tokens with the same dimensions.

Next, training engine 122 executes 404 a series of layers that iteratively transforms the tokens and computes halting scores for the transformed tokens. For example, training engine 122 use the series of layers to process a class token and a set of position-encoded tokens outputted by the encoding network. Each layer could include a transformer block that receives, as input, a set of tokens outputted by a previous layer of the transformer neural network. The transformer block could include an attention unit and/or a multilayer perceptron that convert the inputted tokens into a set of transformed tokens. Each layer could also include a halting module that computes a halting score and a cumulative halting score for each of the transformed tokens. For example, the halting module could compute the halting score for each token by scaling and shifting a certain dimension (e.g., the first dimension) of the token and applying a sigmoid function or another nonlinear function to the result. The halting module could also compute the cumulative halting score for each token as a sum of halting scores for the token from the first layer up to the current layer. When the cumulative halting score exceeds a threshold, training engine 122 could halt the token by zeroing out the value of the token and omitting the computation of attention scores associated with the token by subsequent layers.

Training engine 122 also executes 406 a task network that generates a predictive output based on one or more tokens. For example, training engine 122 could compute a weighted sum of class token values and/or other token values generated by the series of layers. Training engine 122 could also use one or more classification layers in the task network to generate a prediction of one or more classes associated with an image.

Training engine 122 then updates 408 parameters of the encoding network, series of layers, and task network based on one or more losses associated with the halting scores and/or output. For example, training engine 122 could compute a task loss based on a difference between the predictive output of the task network and one or more corresponding labels or “ground truth” values. Training engine 122 could also, or instead, compute a ponder loss based on halting scores, cumulative halting scores, and/or remainders associated with the tokens. Training engine 122 could also, or instead, compute a distributional loss based on a divergence of a distribution of halting scores across the series of layers from a target distribution. Training engine 122 could compute an objective as a weighted combination of the task loss, ponder loss, and/or distributional loss and use gradient descent and backpropagation to update weights in the encoding network, series of layers, and task network in a way that optimizes the objective.

Training engine 122 determines 410 whether training of the transformer neural network is complete. For example, training engine 122 could determine that training is complete when one or more conditions are met. These condition(s) include (but are not limited to) convergence in the parameters of encoding network, series of layers, and task network; the lowering of one or more losses to below a threshold; and/or a certain number of training steps, iterations, batches, and/or epochs. While training of the transformer neural network is not complete, training engine 122 continues performing operations 402-408 using additional input data samples and/or corresponding losses. Training engine 122 ends the process of training the transformer neural network once the condition(s) are met.

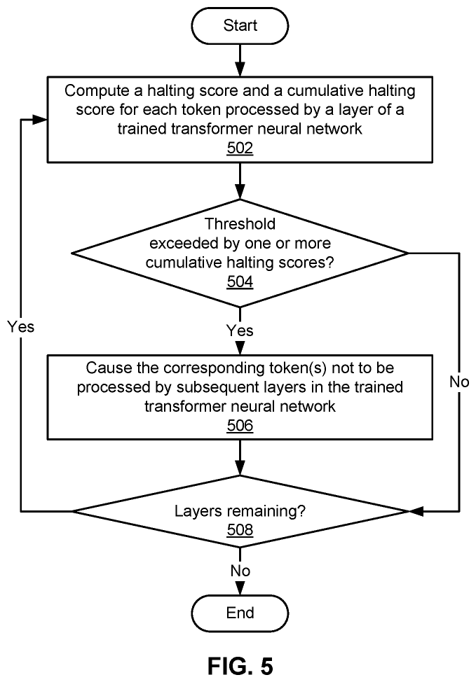

FIG. 5 is a flow diagram of method steps for executing a trained transformer neural network, according to various embodiments. Although the method steps are described in conjunction with the systems of FIGS. 1-2, persons skilled in the art will understand that any system configured to perform the method steps in any order falls within the scope of the present disclosure.

As shown, execution engine 124 computes 502 a halting score and a cumulative halting score for each token processed by a layer of the trained transformer neural network. For example, execution engine 124 could execute a halting module that computes a halting score from one or more dimensions of each token, after the token is outputted by a transformer block in the same layer. Execution engine 124 could also add the halting score to a cumulative halting score for the token from a previous layer to obtain a cumulative halting score for the token at the layer.

Next, execution engine 124 determines 504 whether a threshold is exceeded by one or more cumulative halting scores. For example, execution engine 124 could perform operation 504 by comparing each cumulative halting score to a threshold of 1 or a positive value that is slightly less than 1.

If one or more cumulative halting scores exceed the threshold, execution engine 124 causes 506 the corresponding token(s) not to be processed by subsequent layers in the trained transformer neural network. For example, execution engine 124 could discontinue processing of the token(s) by deleting the tokens or preventing the tokens from being inputted into the next layer of the transformer neural network. If no cumulative halting scores exceed the threshold, execution engine 124 allows all tokens processed by the layer to be processed by the next layer of the transformer neural network.

After tokens processed by the layer are selectively halted based on the corresponding cumulative halting scores, execution engine 124 determines 508 whether layers remain in the transformer neural network. For example, execution engine 124 could determine that no layers remain in the neural network when all tokens have been halted and/or the last layer of the neural network has been used to compute halting scores and cumulative halting scores in operation 502. While layers remain in the transformer neural network, execution engine 124 repeats operations 502-506 for each remaining layer and/or each unhalted token to selectively halt tokens with cumulative halting scores that exceed the threshold. When no layers remain in the transformer neural network, execution engine 124 uses a task network to generate a predictive output based on one or more token values produced by one or more layers, as discussed above.

In sum, the disclosed techniques perform adaptive token depth adjustment in a transformer neural network. A set of tokens is generated from discrete portions of input data and iteratively processed by a series of transformer blocks included in the transformer neural network. A halting module after each transformer block computes a halting score for each token from one or more dimensions in the token. The halting module also computes a cumulative halting score for each token as a sum or another aggregation of existing halting scores for the token. When the cumulative halting score exceeds a threshold, the token is not processed by subsequent transformer blocks or halting modules.

During training of a transformer neural network, parameters of the series of transformed blocks are updated based on a number of losses. The losses include a ponder loss that encourages tokens to be halted before the final transformer block is reached. The losses also, or instead, include a distributional loss that measures the divergence of a distribution of halting scores across the series of transformer blocks from a target distribution. The losses also, or instead, include a task loss that measures the accuracy of the transformer neural network in performing a task based on the set of tokens. The ponder loss, distributional loss, and/or task loss are combined into an overall objective that is used to update parameters of the transformer neural network.

One technical advantage of the disclosed techniques relative to the prior art is that, with the disclosed techniques, the number of tokens processed by a transformer neural network is reduced as inferencing operations proceed. Accordingly, with the disclosed techniques, the transformer neural network can execute more quickly and efficiently than a conventional transformer neural network that processes all input tokens using all layers. The improvements in execution speed and efficiency additionally enable transformer neural networks to be deployed on mobile phones, autonomous vehicles, or other edge devices with limited computational capabilities, memory, power, and/or network bandwidth. Another technical advantage of the disclosed techniques is that the transformer neural network can be trained in a way that balances the accuracy of the transformer neural network in performing a task with the efficiency with which the transformer neural network performs the task. These technical advantages provide one or more technological improvements over prior art approaches.

1. In some embodiments, a computer-implemented method for executing a transformer neural network comprises computing a first set of halting scores for a first set of tokens that has been input into a first layer of the transformer neural network; determining that a first halting score included in the first set of halting scores exceeds a threshold value; and in response to the first halting score exceeding the threshold value, causing a first token that is included in the first set of tokens and is associated with the first halting score not to be processed by one or more layers within the transformer neural network that are subsequent to the first layer.

2. The computer-implemented method of clause 1, further comprising computing one or more losses based on a second set of halting scores computed for a second set of tokens; and modifying at least one layer included in the transformer neural network based on the one or more losses as part of training the transformer neural network.

3. The computer-implemented method of any of clauses 1-2, wherein computing the one or more losses comprises computing a ponder loss based on the second set of halting scores and a set of layers included in the transformer neural network associated with halting the second set of tokens.

4. The computer-implemented method of any of clauses 1-3, wherein computing the one or more losses comprises aggregating the second set of halting scores into a distribution of halting scores across a series of layers included in the transformer neural network; and computing a distributional loss based on a divergence of the distribution of halting scores from a target distribution.

5. The computer-implemented method of any of clauses 1-4, wherein computing the one or more losses comprises computing a task loss associated with a prediction generated by a task network based on the second set of tokens.

6. The computer-implemented method of any of clauses 1-5, wherein modifying the at least one layer of the transformer neural network comprises updating parameters associated with the first layer and the one or more layers based on a weighted combination of the one or more losses.

7. The computer-implemented method of any of clauses 1-6, wherein computing the first set of halting scores comprises applying a nonlinear function to a dimension of a token.

8. The computer-implemented method of any of clauses 1-7, wherein computing the first set of halting scores comprises shifting and scaling the dimension prior to applying the nonlinear function.

9. The computer-implemented method of any of clauses 1-8, wherein computing the first set of halting scores for the first set of tokens comprises aggregating a second set of halting scores computed for the first set of tokens by a layer included in the transformer neural network that precedes the first layer and a third set of halting scores computed for the first set of tokens by the first layer.

10. The computer-implemented method of any of clauses 1-9, wherein causing the first token to not be processed by the one or more layers comprises removing the first token from the first set of tokens prior to inputting the first set of tokens into the one or more layers that are subsequent to the first layer.

11. In some embodiments, one or more non-transitory computer-readable media store instructions that, when executed by one or more processors, cause the one or more processors to perform the steps of computing a first set of halting scores for a first set of tokens that has been input into a first layer of a transformer neural network; determining that a first halting score included in the first set of halting scores exceeds a threshold value; and in response to the first halting score exceeding the threshold value, causing a first token that is included in the first set of tokens and is associated with the first halting score not to be processed by one or more layers within the transformer neural network that are subsequent to the first layer.

12. The one or more non-transitory computer-readable media of clause 11, wherein the instructions further cause the one or more processors to perform the steps of computing one or more losses based on a second set of halting scores for a second set of tokens; and modifying at least one layer included in the transformer neural network based on the one or more losses as part of training the transformer neural network.

13. The one or more non-transitory computer-readable media of any of clauses 11-12, wherein computing the one or more losses comprises computing a ponder loss based on the second set of halting scores and a set of layers included in the transformer neural network associated with halting the second set of tokens.

14. The one or more non-transitory computer-readable media of any of clauses 11-13, wherein computing the one or more losses comprises aggregating the second set of halting scores into a distribution of halting scores across a series of layers included in the transformer neural network; and computing a distributional loss based on a Kullback-Leibler divergence of the distribution of halting scores from a target distribution.

15. The one or more non-transitory computer-readable media of any of clauses 11-14, wherein computing the one or more losses comprises computing a task loss associated with a prediction generated by a task network based on a weighted sum of values of a class token included in the second set of tokens.

16. The one or more non-transitory computer-readable media of any of clauses 11-15, wherein computing the first set of halting scores for the first set of tokens comprises applying a sigmoid function to a combination of a dimension of a token, a shifting parameter, and a scaling parameter.

17. The one or more non-transitory computer-readable media of any of clauses 11-16, wherein computing the first set of halting scores for the first set of tokens comprises summing a second set of halting scores computed for the first set of tokens by a layer included in the transformer neural network that precedes the first layer and a third set of halting scores computed for the first set of tokens by the first layer.

18. The one or more non-transitory computer-readable media of any of clauses 11-17, wherein causing the first token not to be processed by the one or more layers comprises omitting the computation of one or more attention scores associated with the first token by the one or more layers that are subsequent to the first layer.

19. The one or more non-transitory computer-readable media of any of clauses 11-18, wherein the instructions further cause the one or more processors to perform the step of converting a set of patches included in an input image into the first set of tokens.

20. In some embodiments, a system comprises one or more memories that store instructions, and one or more processors that are coupled to the one or more memories and, when executing the instructions, are configured to compute a first set of halting scores for a first set of tokens that has been input into a first layer of a transformer neural network; determine that a first halting score included in the first set of halting scores exceeds a threshold value; and in response to the first halting score exceeding the threshold value, cause a first token that is included in the first set of tokens and is associated with the first halting score not to be processed by one or more layers within the transformer neural network that are subsequent to the first layer.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for executing a transformer neural network, the method comprising:
computing a first set of halting scores for a first set of tokens that has been input into a first layer of the transformer neural network;
determining that a first halting score included in the first set of halting scores exceeds a threshold value; and
in response to the first halting score exceeding the threshold value, causing a first token that is included in the first set of tokens and is associated with the first halting score not to be processed by one or more layers within the transformer neural network that are subsequent to the first layer.

2. The computer-implemented method of claim 1, further comprising:
computing one or more losses based on a second set of halting scores computed for a second set of tokens; and
modifying at least one layer included in the transformer neural network based on the one or more losses as part of training the transformer neural network.

3. The computer-implemented method of claim 2, wherein computing the one or more losses comprises computing a ponder loss based on the second set of halting scores and a set of layers included in the transformer neural network associated with halting the second set of tokens.

4. The computer-implemented method of claim 2, wherein computing the one or more losses comprises:
aggregating the second set of halting scores into a distribution of halting scores across a series of layers included in the transformer neural network; and
computing a distributional loss based on a divergence of the distribution of halting scores from a target distribution.

5. The computer-implemented method of claim 2, wherein computing the one or more losses comprises computing a task loss associated with a prediction generated by a task network based on the second set of tokens.

6. The computer-implemented method of claim 2, wherein modifying the at least one layer of the transformer neural network comprises updating parameters associated with the first layer and the one or more layers based on a weighted combination of the one or more losses.

7. The computer-implemented method of claim 1, wherein computing the first set of halting scores comprises applying a nonlinear function to a dimension of a token.

8. The computer-implemented method of claim 7, wherein computing the first set of halting scores comprises shifting and scaling the dimension prior to applying the nonlinear function.

9. The computer-implemented method of claim 1, wherein computing the first set of halting scores for the first set of tokens comprises aggregating a second set of halting scores computed for the first set of tokens by a layer included in the transformer neural network that precedes the first layer and a third set of halting scores computed for the first set of tokens by the first layer.

10. The computer-implemented method of claim 1, wherein causing the first token to not be processed by the one or more layers comprises removing the first token from the first set of tokens prior to inputting the first set of tokens into the one or more layers that are subsequent to the first layer.

11. One or more non-transitory computer-readable media storing instructions that, when executed by one or more processors, cause the one or more processors to perform the steps of:
computing a first set of halting scores for a first set of tokens that has been input into a first layer of a transformer neural network;
determining that a first halting score included in the first set of halting scores exceeds a threshold value; and
in response to the first halting score exceeding the threshold value, causing a first token that is included in the first set of tokens and is associated with the first halting score not to be processed by one or more layers within the transformer neural network that are subsequent to the first layer.

12. The one or more non-transitory computer-readable media of claim 11, wherein the instructions further cause the one or more processors to perform the steps of:
computing one or more losses based on a second set of halting scores for a second set of tokens; and
modifying at least one layer included in the transformer neural network based on the one or more losses as part of training the transformer neural network.

13. The one or more non-transitory computer-readable media of claim 12, wherein computing the one or more losses comprises computing a ponder loss based on the second set of halting scores and a set of layers included in the transformer neural network associated with halting the second set of tokens.

14. The one or more non-transitory computer-readable media of claim 12, wherein computing the one or more losses comprises:
aggregating the second set of halting scores into a distribution of halting scores across a series of layers included in the transformer neural network; and
computing a distributional loss based on a Kullback-Leibler divergence of the distribution of halting scores from a target distribution.

15. The one or more non-transitory computer-readable media of claim 12, wherein computing the one or more losses comprises computing a task loss associated with a prediction generated by a task network based on a weighted sum of values of a class token included in the second set of tokens.

16. The one or more non-transitory computer-readable media of claim 11, wherein computing the first set of halting scores for the first set of tokens comprises applying a sigmoid function to a combination of a dimension of a token, a shifting parameter, and a scaling parameter.

17. The one or more non-transitory computer-readable media of claim 11, wherein computing the first set of halting scores for the first set of tokens comprises summing a second set of halting scores computed for the first set of tokens by a layer included in the transformer neural network that precedes the first layer and a third set of halting scores computed for the first set of tokens by the first layer.

18. The one or more non-transitory computer-readable media of claim 11, wherein causing the first token not to be processed by the one or more layers comprises omitting the computation of one or more attention scores associated with the first token by the one or more layers that are subsequent to the first layer.

19. The one or more non-transitory computer-readable media of claim 11, wherein the instructions further cause the one or more processors to perform the step of converting a set of patches included in an input image into the first set of tokens.

20. A system, comprising:
one or more memories that store instructions, and
one or more processors that are coupled to the one or more memories and, when executing the instructions, are configured to:
compute a first set of halting scores for a first set of tokens that has been input into a first layer of a transformer neural network;
determine that a first halting score included in the first set of halting scores exceeds a threshold value; and
in response to the first halting score exceeding the threshold value, cause a first token that is included in the first set of tokens and is associated with the first halting score not to be processed by one or more layers within the transformer neural network that are subsequent to the first layer.
